(19) United States
(12) Patent Application Publication
(10) Pub. No.: US 2007/0248358 A1
(43) Pub. Date: Oct. 25, 2007

(54) Electrical-optical cable for wireless systems

(76) Inventor: Michael Sauer, Corning, NY (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/406,976

(22) Filed: Apr. 19, 2006

(51) Int. Cl. H04B 10/00

(52) U.S. Cl. 398/115

(57) ABSTRACT

An electrical-optical cable for wireless system that includes two electrical-to-optical (E/O) converter units optically and electrically coupled via a cord that includes a downlink optical fiber, an uplink optical fiber, and an electrical power link. The first E/O converter receives radio-frequency (RF) electrical signals from an access point device, converts them to corresponding RF optical signals, and transmits the optical signals over the downlink optical fiber to the second E/O converter. The second E/O converter receives and converts the RF optical signals back to the original RF electrical signals. The RF electrical signals at one of the E/O converter units drive an antenna connected thereto. RF signals received by the wireless antenna are processed in a similar manner, with the optical signals being sent to the other E/O converter unit over the uplink optical fiber. The electrical-optical cable allows for the remote placement of the antenna relative to an access point device, with the antenna-side E/O converter unit power by electrical power provided by the other E/O converter unit.

### BACKGROUND OF THE INVENTION

1. Field of the Invention

The present invention relates generally to wireless communication systems, and particularly to a cable capable of carrying both radio-frequency (RF) optical signals and electrical power from a wireless access point device to a remote antenna.

2. Technical Background

Wireless communication is rapidly growing, with ever increasing demands for high-speed mobile data communication. As an example, so-called “wireless fidelity” or “WiFi” systems are being deployed in many different types of areas (coffee shops, airports, libraries, etc.) for high-speed wireless Internet access.

In a WiFi system, localized wireless coverage is provided by an electronic digital RF signal transmitter/receiver device (hereinafter, “WiFi device”) that includes an access point device (also called a “WiFi box” or “wireless access point”), and an antenna connected thereto. There are often constraints as to where WiFi device can be located, particularly for in-door WiFi coverage. Because antenna location dictates the WiFi coverage area, the antenna is typically placed in a strategic location to maximize coverage. For indoor locations, for example, the optimum antenna position is often at or close to a ceiling.

In many cases, the physical dimensions of the WiFi device are not suited for the WiFi box to be installed at the same location as the antenna. Thus, the antenna is placed at a distance from the WiFi box and is connected thereto by a cable, typically a coaxial cable. The cable carries the transmission radio-frequency (RF) signal from the WiFi box to the antenna, and also carries the received RF signal from the antenna to the WiFi box. The cable is transparent to the RF signal, i.e., it transports the signal independent of the modulation format, error coding, exact center frequency, etc. The signal carried by the cable is the same RF signal radiated over the wireless link.

An important requirement for a WiFi system is that the RF signal quality not be substantially degraded by the cable. While the typical coaxial cable used in a WiFi system can be quite long, the use of a long coax cable is problematic when the cable loss at the frequencies of interest is too high to maintain the needed signal quality. Unfortunately, overcoming the cable loss problem by electrical signal amplification is limited to moderate loss levels because strong signal amplification reduces the signal-to-noise ratio (SNR).

### SUMMARY OF THE INVENTION

One aspect of the invention is an electrical-optical cable apparatus for a wireless system. The cable includes first and second optical fibers, and an electrical power line. The cable also includes first and second electrical-optical (E/O) converter units that are optically coupled to respective opposite ends of the first and second optical fibers, and that are electrically coupled to the respective opposite ends of the electrical power line. The electrical power line provides electrical power from the first to the second E/O converter unit so that the second E/O converter unit does not need to be connected to a separate power source. Each E/O converter unit has one or more RF electrical connectors adapted to receive and/or transmit RF electrical signals. The E/O converter units are adapted to convert the RF electrical signals into RF optical signals and vice versa, so as to provide RF signal communication between the RF electrical connectors of the first and second E/O converter units via the first and second optical fibers.

Another aspect of the invention is an electrical-optical cable apparatus for sending RF signals between an access point device and a wireless antenna. The cable includes an E/O converter unit electrically coupled to the access point device so as to receive input RF electrical signals and input electrical power. The cable apparatus also includes a second E/O converter unit electrically coupled to the antenna. The cable apparatus has a cord operably connecting the first and second E/O converter units. The cord has downlink and uplink optical fibers, an electrical power line, and optionally a protective sheath. The electrical power line provides electrical power from the first E/O converter unit to the second E/O converter unit. Both E/O converter units are adapted to convert RF electrical signals into RF optical signals and vice versa, so as to provide RF signal communication between the access point and the antenna.

Another aspect of the invention is a method of transmitting RF signals between an access point device and a wireless antenna. The method includes converting first RF electrical signals generated at the access point device into corresponding first RF optical signals at a first E/O converter unit. The method also includes transmitting the first RF optical signals over a first optical fiber from the first E/O converter unit to a second E/O converter unit. The method further includes converting the first RF optical signals back to the first RF electrical signals at the second E/O converter unit. The method also includes driving the antenna with the first RF electrical signals at the second E/O converter unit. The method further includes powering the second E/O converter unit with power transmitted from the first E/O converter unit.

Additional features and advantages of the invention are set forth in the detailed description that follows, and will be readily apparent to those skilled in the art from that description or recognized by practicing the invention as described herein, including the detailed description that follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a schematic diagram of an example embodiment of an electrical-optical cable according to the present invention;

FIG. 2 is close-up schematic diagram of an example embodiment of an access-point-side E/O converter unit that includes two electrical connectors;

FIG. 3 is a close-up schematic diagram of an example embodiment of an antenna-side E/O converter unit having two RF electrical connectors each operably coupled to a separate antenna;

FIG. 4 is a schematic diagram of an example embodiment of the cable of the present invention in which the E/O converter units each have two antennae;

FIG. 5 is schematic diagram of an example embodiment of a WiFi system that employs the electrical-optical cable of the present invention;

FIG. 6 is a close-up schematic diagram of the antenna-side of the electrical-optical cable of the present invention similar to that of FIG. 1, wherein the electrical power line includes two wires coupled to a DC/DC converter at the antenna-end E/O converter unit;

FIG. 7 is a schematic diagram of a WiFi system similar to that shown in FIG. 5, illustrating how the cable of the present invention is used in a building to remotely locate a WiFi cell or “hot spot” away from a WiFi box;

FIG. 8 is a schematic diagram of an example embodiment of a cable according to the present invention that includes two patchcord extensions; and

FIG. 9 is a close-up view of the central portion of the cable of FIG. 8, showing the details of a patchcord section and the engaged E-O couplers used to join sections of the cable cord to extend the length of the cable.

### DETAILED DESCRIPTION OF THE PREFERRED EMBODIMENTS

Reference is now made in detail to the present preferred embodiments of the invention, examples of which are illustrated in the accompanying drawings. Whenever possible, the same or analogous reference numbers (e.g., the same number, but with an “A” or a “B” suffix) are used throughout the drawings to refer to the same or like parts.

In the description below, the term “RF signal” refers to a radio-frequency signal, whether electrical or optical, while the terms “RF electrical signal” and “RF optical signal” denote the particular type of RF signal.

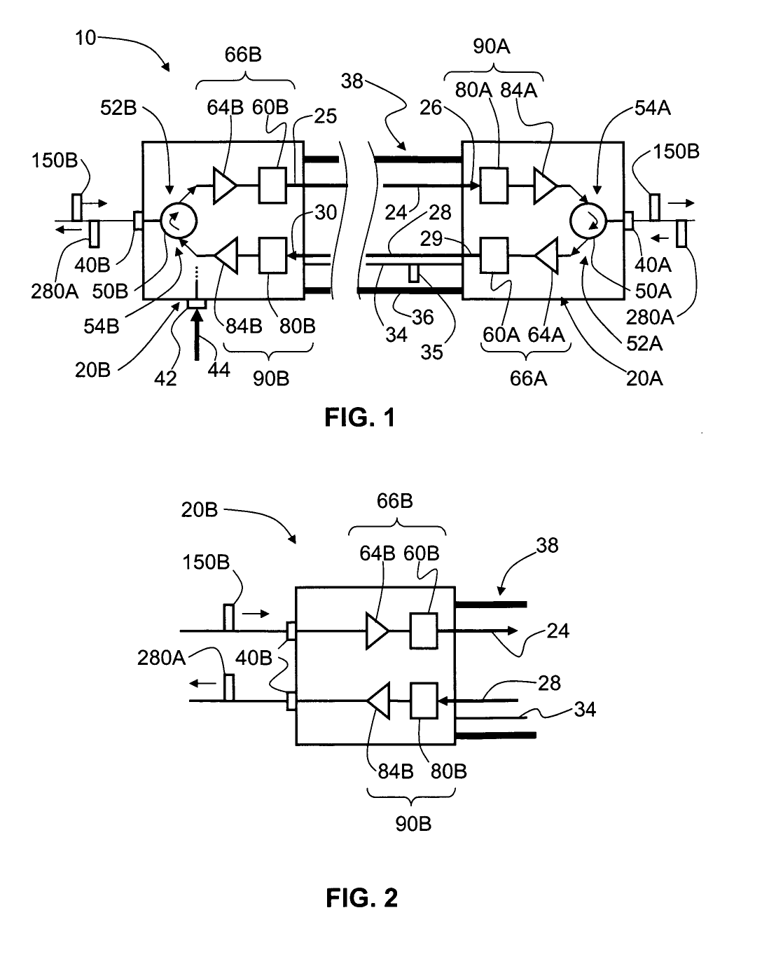

FIG. 1 is a schematic diagram of an example embodiment of an electrical-optical cable apparatus (“cable”) 10 according to the present invention. Cable 10 includes a first electrical-to-optical (E/O) converter unit 20A, which for the sake of illustration and orientation is associated with the antenna-side of a WiFi system (not shown). Cable 10 also includes a similar if not identical E/O converter unit 20B at the WiFi-box (i.e., the access-point-device side). E/O converter units 20A and 20B are optically coupled in one direction by a downlink optical fiber 24 that has an input end 25 optically coupled to E/O converter unit 20B, and an output end optically coupled to E/O converter unit 20A. E/O converter units 20A and 20B are also optically coupled in the opposite direction by an uplink optical fiber 28 that has an input end 29 optically coupled to E/O converter unit 20A and an output end 30 optically coupled to E/O converter unit 20A. In example embodiments, downlink and uplink optical fibers 24 and 28 are either single-mode optical fibers or multi-mode optical fibers, the choice of which is discussed in greater detail below.

Cable 10 also includes an electrical power line 34 that electrically couples E/O converter units 20A and 20B and that conveys electrical power from E/O converter unit 20B to E/O converter unit 20A via an electrical power signal 35. In an example embodiment, electrical power line includes standard electrical-power-carrying electrical wire, e.g., 18-26 AWG (American Wire Gauge) used in standard telecommunications applications. Example embodiments of electrical power line 34 are discussed below.

Cable 10 also preferably includes a protective sheath 36 that covers and protects downlink and uplink optical fibers 24 and 28, and electrical power line 34. Downlink optical fiber 24, uplink optical fiber 28, and electrical power line 34 constitute a cable cord 38. In an example embodiment, cable cord 38 also includes protective sheath 36.

E/O converter units 20A and 20B each include one or more respective RF electrical connectors (“connectors”) 40A and 40B. In an example embodiment, connectors 40A and 40B are a standard type of coaxial cable connector, such as SMA, reverse SMA, TNC, reverse TNC, or the like. It is worth noting that RF adapters for use with different connector types are widely commercially available, so that cable 10 can be adapted to any RF coaxial interface on the access-point-device side or the antenna side of the cable. E/O converter unit 20B also includes an electrical power connector 42 adapted to receive an input electrical power line 44 that provides power to cable 10. In an example embodiment, input electrical power line 44 comes from a power supply 92 (not shown in FIG. 1; see FIG. 2, below), which would typically be plugged into a conventional electrical outlet or a power supply.

In an example embodiment where a single electrical connector 40B is desired, E/O converter unit 20B includes a signal-directing element 50B, such as an electrical circulator or RF switch (e.g., a 2:1 RF switch) electrically coupled to connector 40B. Signal-directing element 50B includes an output port 52B and an input port 54B, and serves to separate the downlink and uplink RF electrical signals, as discussed below.

E/O converter unit 20B also includes a laser 60B electrically coupled to output port 52B. Laser 60B is also optically coupled to input end 25 of downlink optical fiber 24. Optionally included between laser 60B and output port 52B is a laser driver/amplifier 64B. Depending on the RF power level and type of laser 60B used, laser driver/amplifier 64B may or may not be required. Laser 60B—or alternatively, laser 60B and laser driver/amplifier 64B—constitute a transmitter 66B. In an example embodiment, laser driver/amplifier 64B serves as an impedance-matching circuit element in the case that the impedance of laser 60B does not match that of connector 40B (e.g., the industry-standard 50 ohms). However, this impedance matching can be done at any point in the RF component sequence.

Laser 60B is any laser suitable for delivering sufficient dynamic range for RF-over-fiber applications. Example lasers suitable for laser 60B include laser diodes, distributed feedback (DFB) lasers, Fabry-Perot (FP) lasers, and vertical cavity surface emitting lasers (VCSELs). In an example embodiment, the wavelength of laser 60B is one of the standard telecommunication wavelengths, e.g., 850 nm, 1330 nm, or 1550 nm. In another example embodiment, non-telecom wavelengths, such as 980 nm, are used. In an example embodiment, laser 60B is uncooled to minimize cost, power consumption, and size.

Laser 60B can be a single-mode laser or multi-mode laser, with the particular lasing mode depending on the particular implementation of cable 10. In the case where multi-mode optical fiber is used for downlink optical fiber 24, laser 60B can be operated in single-mode or multi-mode. On the other hand, single-mode optical fiber can be used for downlink optical fiber 24 for relatively long cables (e.g., >1 km), as well as for shorter distances. In the case where downlink and/or uplink optical fiber 24 and 28 are single-mode, the corresponding laser needs to be single mode.

Multi-mode optical fiber is typically a more cost-effective option for the optical fiber downlinks and uplinks of cable 10 when the cable is relatively short, e.g., for within-building applications where the cable is a few meters, tens of meters, or even a few hundred meters. The particular type of multi-mode optical fiber used depends on the cable length and the frequency range of the particular application. An example of where cable 10 should find great applicability is in WiFi systems operating in frequency bands around 2.4 GHz or 5.2 GHz. Standard 50 μm multi-mode optical fiber is particularly suitable for downlink and/or uplink optical fibers for cable lengths of up to, say, 100 meters. On the other hand, high-bandwidth multi-mode optical fiber is particularly suitable for cable lengths of up to 1000 meters.

With continuing reference to FIG. 1, E/O converter unit 20B further includes a photodetector 80B optically coupled to output end 30 of optical fiber uplink 28. In an example embodiment, a linear transimpedance amplifier 84B is electrically coupled to the photodetector as well as to signal-directing element 50B at input port 54B. Photodetector 80B—or photodetector 80B and linear amplifier 84B—constitute a photoreceiver 90B. Any impedance matching between a 50 ohm coaxial connector 40B and the higher impedance of photodetector 80B is preferably accomplished using transimpedance amplifier 84B. The remainder of the system is preferably matched to a standard impedance, e.g., 50 ohms.

The construction of E/O converter 20A at the antenna side is the same as or is essentially the same as that of 20B, with like reference numbers representing like elements. Thus, E/O converter unit 20A includes a photoreceiver 90A and a transmitter 66A. In photoreceiver 90A, photodetector 80A is optically coupled to output end 26 of downlink optical fiber 24, while in transmitter 66A, laser 60A is optically coupled to input end 29 of uplink optical fiber 28. Transmitter 66A and photoreceiver 90A are respectively coupled to output port 52A and input port 54A of signal-directing element 50A.

FIG. 2 is close-up schematic diagram of an example embodiment of E/O converter unit 20B that includes two electrical connectors 40B. The use of two electrical connectors 40B obviates the need for signal-directing element 50B. In the example embodiment of FIG. 2, the upper connector 40B receives input RF electrical signals 150B and lower connector 40B outputs RF electrical signals 280A (RF electrical signals 150B and 280A are discussed in greater detail below).

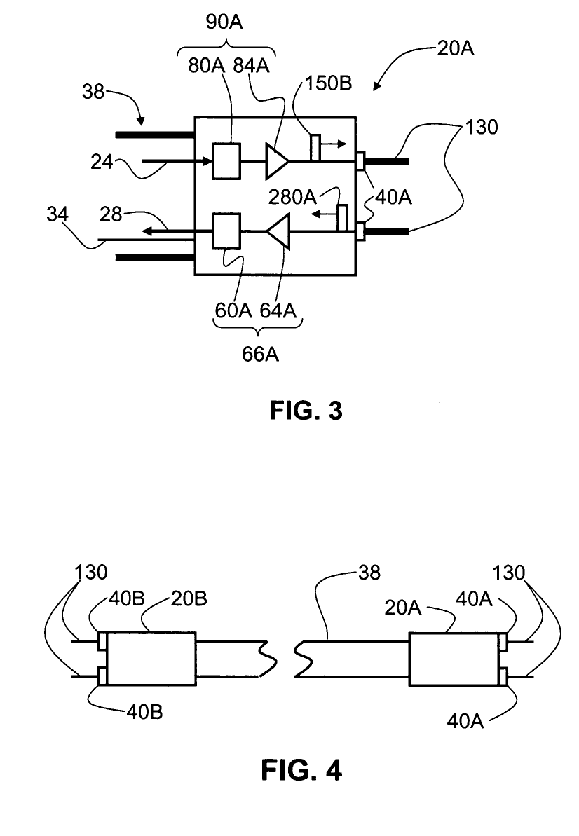

FIG. 3 is a close-up schematic diagram of an example embodiment of E/O converter unit 20A having two RF electrical connectors 40A each operably coupled to separate antennae 130, wherein the upper antenna is a transmitting antenna and the lower antenna is a receiving antenna. Again, this two-connector embodiment eliminates the need for signal-directing element 50A. In an example embodiment, both E/O converter units 20A and 20B have dual connectors 40A and 40B on each side. Further in this example embodiment, both E/O converter units have a pair of antennae 130 electrically connected to their respective pair of electrical connectors, as illustrated in the schematic diagram of cable 10 of FIG. 4.

Various additional electronic circuit elements, such as bias tees, RF filters, amplifiers, frequency dividers, etc., are not shown in the Figures for ease of explanation and illustration. The application of such elements to the cable of the present invention will be apparent to one skilled in the art.

### Example Method of Operation

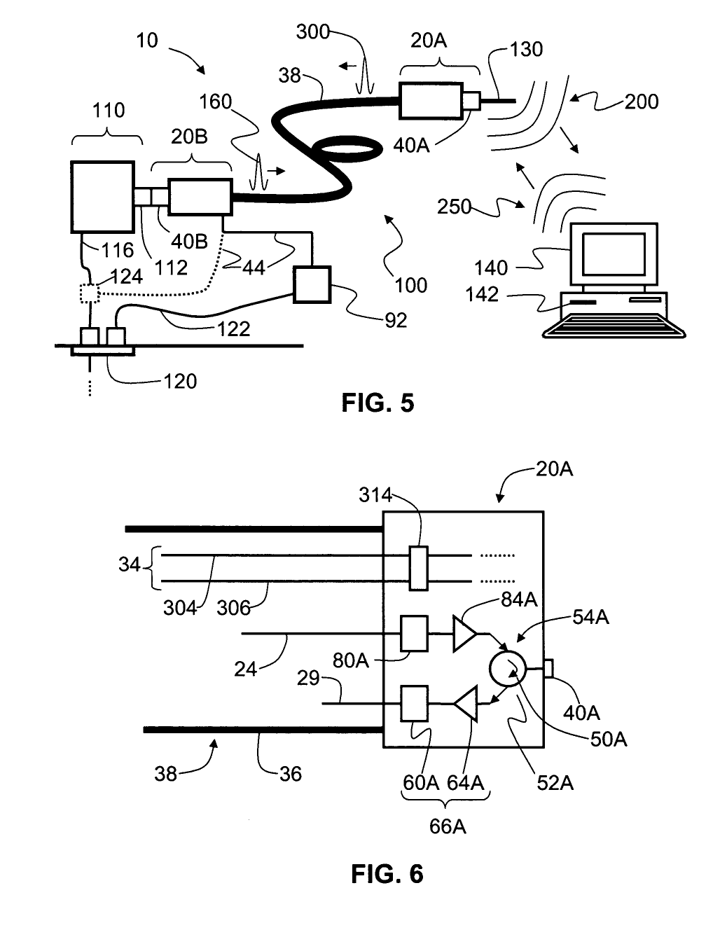

FIG. 5 is a schematic diagram of an example WiFi system 100 that includes an example embodiment of cable 10 of the present invention. Cable 10 is used in WiFi system 100 as a transparent ˜0 dB loss cable for operably connecting a remote antenna to a WiFi access point device. WiFi system 100 includes an RF electrical signal source 110, which in an example embodiment is an access point device or a WiFi box. RF electrical signal source 110 includes a connector 112, which is connected to connector 40B of E/O converter unit 20B of cable 10. RF electrical signal source 110 includes an electrical power cord 116 that plugs into a conventional electrical outlet 120 or other power supply. WiFi system 100 also includes a power supply 92 electrically coupled to E/O converter unit via input electrical power line 44, and is plugged into electrical outlet 120 via an electrical power cord 122. In an example embodiment, RF electrical signal source 110 is plugged into power supply 92 rather than electrical outlet 120. In another example embodiment, input electrical power line 44 is tapped off of electrical power cord 116 via an electrical power tap 124, as illustrated by dashed lines in FIG. 5. In an example embodiment, power tap 124 has receptacles (not shown) for receiving a first section of power cord 116 from electrical outlet 120, and for receiving a second section of power cord 116 from RF electrical signal source 110. Electrical power tap 124 taps off some electrical power from power cord 116 to power E/O converters 20A and 20B. Since E/O converters 20A and 20B operate using low power levels, the additional power requirement is not a significant constraint to the rating of power cord 116.

WiFi system 100 also includes an antenna 130 electrically coupled to E/O converter unit 20A, e.g., via connector 40A. A computer 140 or like device having a wireless communication unit 142, such as a wireless card, is in wireless RF communication with WiFi system 100.

With reference to the example embodiment of cable 10 of FIG. 1 and the WiFi system 100 of FIG. 5, in the operation of the WiFi system, RF electrical signal unit 110 generates downlink RF electrical signals 150B (FIG. 1) that travel to E/O converter unit 20B and to signal-directing element 50B therein. Signal-directing element 50B directs downlink RF electrical signals 150B to laser driver/amplifier 64B. Laser driver/amplifier 64B amplifies the downlink RF electrical signals and provides the amplified signals to laser 60B. Amplified downlink RF electrical signals 150B drive laser 60B, thereby generating downlink RF optical signal 160. These optical signals are inputted into downlink optical fiber 24 at input end 25 and travel down this optical fiber, where they exit at optical fiber output end 26 at E/O converter unit 20A. Photodetector 80A receives the transmitted downlink RF optical signals 160 and coverts them back to downlink RF electrical signals 150B. Transimpedance amplifier 84A amplifies downlink RF electrical signals 150B (FIG. 1), which then travel to signal-directing element 50A. Signal-directing element 50A then directs the signals to connector 40A and to antenna 130.

Downlink RF electrical signals 150B drive antenna 130, which radiates a corresponding downlink RF wireless signal 200 in the form of RF electromagnetic waves. The RF wireless signals 200 are received by wireless communication unit 142 in computer 140. Wireless communication unit 142 converts RF wireless signals 200 into a corresponding electrical signal (not shown), which is then processed by computer 140.

Computer 140 also generates uplink electrical signals (not shown), which wireless communication unit 142 converts to uplink wireless RF signals 250 in the form of RF electromagnetic waves. Uplink RF wireless signals 250 are received by antenna 130, which converts these signals into uplink RF electrical signals 280A. Uplink RF electrical signals 280A enter E/O converter unit 20A at connector 40A (FIG. 1) and are directed to transmitter 66A by signal-directing element 50A. Transmitter 66A, which operates in the same manner as transmitter 66B, converts the uplink RF electrical signals 280A into corresponding uplink RF optical signals 300. Uplink RF optical signals 300 are coupled into input end 29 of uplink optical fiber 28, travel over this optical fiber, and exit at optical fiber output end 30 at E/O converter unit 20B. Photoreceiver 90B receives uplink RF optical signals 300 and converts them back to uplink RF electrical signals 280A (FIG. 1). Uplink RF electrical signals 280A then travel to signal-directing element 50B, which directs these signals to connector 40B and into RF electrical signal unit 110, which then further processes the signals (e.g., filters the signals, sends the signals to the Internet, etc.).

Electrical Power Delivery

As discussed above, the electrical power for driving transmitter 66B, photoreceiver 90B, and signal-directing element 50B (if present and if it requires power) in E/O converter unit 20B is provided by input electrical power line 44, which in an example embodiment originates from power supply 92. Power for driving transmitter 66A, photoreceiver 90A, and signal-directing element 50A (if present and if it requires power) at E/O converter unit 20A is provided by electrical power line 34, which as discussed above, is included in cable cord 38. A preferred embodiment of cable 10 of the present invention has relatively low power consumption, e.g., on the order of a few watts.

FIG. 6 is a close-up schematic diagram of the antenna-side of cable 10 illustrating an example embodiment wherein electrical power line 34 includes two wires 304 and 306 electrically coupled to a DC/DC power converter 314 at E/O converter unit 20A. The DC/DC power converter 314 changes the voltage of the power signal to the power level(s) required by the power-consuming components in E/O converter unit 20A. In an example embodiment, wires 304 and 306 are included in respective optical fiber jackets (not shown) that surround downlink and uplink optical fibers 24 and 28. In an example embodiment similar to that shown in FIG. 6, electrical power line 34 includes more than two wires that carry different voltage levels.

Forming a Remote WiFi Cell or “Hot Spot”

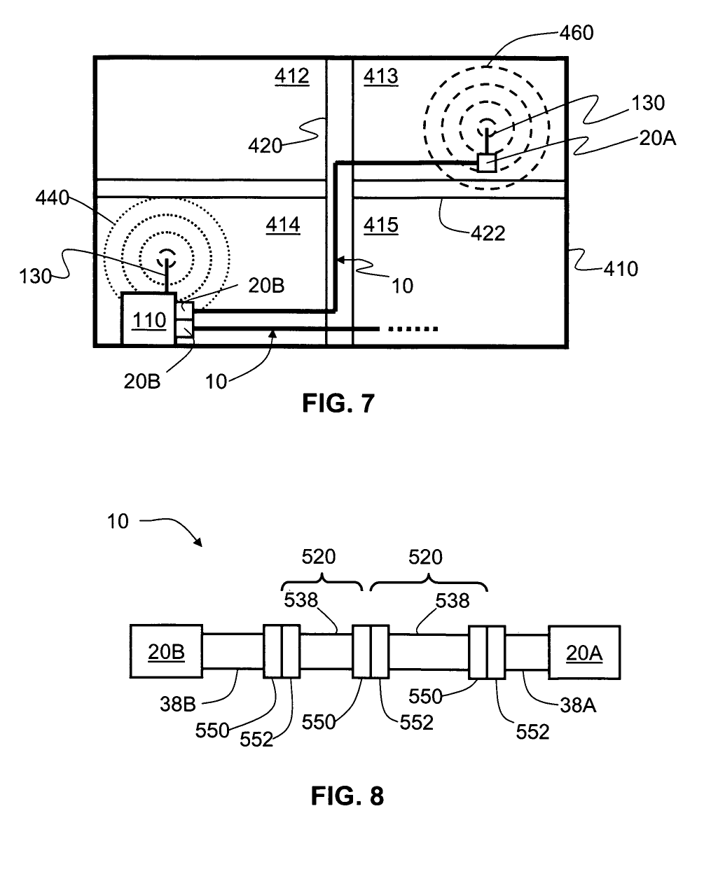

FIG. 7 is a schematic diagram of an example embodiment of WiFi system 100, illustrating how cable 10 of the present invention is used to remotely locate a WiFi cell or “hot spot” in a building relative to a typical WiFi hot spot being located at or near the WiFi box 110. FIG. 7 shows an internal building structure 410 with four separate rooms 412, 413, 414 and 415, defined by intersecting interior walls 420 and 422. WiFi box 110 is located in room 414 and is shown with antenna 130 attached thereto in the conventional manner. Associated with WiFi box 110 is a localized WiFi “hot spot” 440 that covers most if not all of room 414 by virtue of antenna 130 being located close to if not directly on WiFi box 430.

Also shown in FIG. 7 is a cable 10 of the present invention connected to WiFi box 110 at E/O converter unit 20B, with antenna 130 connected to E/O converter unit 20A. Cable 10 runs through wall 420 and extends into room 413. This configuration creates a new WiFi hot spot 460 in room 413 relatively far away from original hot spot 440 in room 414. Cable 10 thus facilitates locating a WiFi antenna (and thus the associated WiFi cell) a relatively remote distance from the WiFi box.

In an example embodiment of the arrangement shown in FIG. 7, two antennas 130 are used at once—one at WiFi box 110, and one remote antenna electrically connected to E/O converter unit 20A. This multiple antenna arrangement provides both local and remote (and optionally overlapping) WiFi hot spots 440 and 460 at the same time. In addition, several cables 10 can be connected to a WiFi box 110 having multiple RF cable connections (two such cables 10 are shown in FIG. 7). When a local antenna 130 and a cable 10 is used, or when multiple cables 10 are used, RF power splitters or dividers (not shown) are used to split the RF signal.

Compact Cable Design

In an example embodiment, cable 10 of the present invention is made compact, i.e., so that E/O converter units 20A and 20B are small, and that cord 10 has a relatively small diameter. For example, cable 10 of the present invention has a size on the order of conventional coaxial cable so that it fits through the same or similar sized holes in walls, bulkheads, etc., as used for conventional coaxial cable. Present-day electronics and photonics are such that E/O converter units 20A and 20B can be made with a high degree of integration, so that the respective ends of cable 10 have about the same size as conventional coaxial cable connector.

In addition, in an example embodiment of cable 10, E/O converter units 20A and 20B are removable, e.g., they removably engage and disengage the respective cable ends so that they can be easily removed and replaced.

Electrical-Optical Cable with Patchcord Extensions

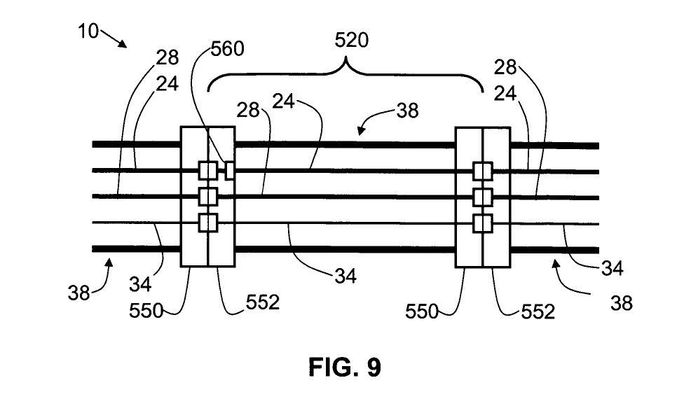

FIG. 8 is a schematic illustration of an example embodiment of electrical-optical cable 10 of the present invention that includes one or more electrical-optical patchcord extensions (“patchcords”) 520. FIG. 9 is a close-up view of the central portion of cable 10 showing the details of patchcord 520, along with the modifications made to cable 10, as described above, to accommodate the addition of one or more patchcords 520 that extend the length of the cable.

With reference to FIG. 8 and FIG. 9, an example embodiment cable 10 as described above is modified by dividing cord 38 (which in this example embodiment is referred to as the “main cord”) at a point along its length to form two main cord sections 38A and 38B. Engageable electrical-optical (E-O) couplers 550 and 552 are then placed at the respective exposed ends. Cable 10 of the present example embodiment also includes one or more patchcords 520 each formed from a section 538 of (main) cord 38 and terminated at its respective ends by a pair of E-O couplers 552 and 550. E-O couplers 552 and 550 are adapted to engage so as to operatively couple downlink optical fiber 24, uplink optical fiber 28 and electrical power line 34 to adjacent cord sections. The use of one or more patchcords 520 allows for both optical signals and electrical power to be transferred over a variety of cable lengths simply by adding or removing patchcords from the cable.

A potential issue with using one or more patchcords 520 is the increased loss due to the increased number of connections. However, RF amplifiers such as one or more of amplifiers 64A, 64B and 84A, 84B can be used to compensate for such loss. Also, in an example embodiment, optical amplifiers 560 (FIG. 9) are placed in E-O couplers 550 and/or 552 to boost the optical signal.

Example Frequency Ranges

In an example embodiment, the RF frequency range of the present invention falls between 2.4 GHz and 5.2 GHz, which covers both ISM frequency bands used in WiFi systems. These frequencies are readily obtainable with commercially available high-speed lasers, transmitters and photoreceivers. In another example embodiment, the frequency range of the present invention falls between 800 MHz and up to (a) 2.4 GHz; or (b) 5.2 GHz; or (c) 5.8 GHz. In an example embodiment, the frequency range is selected to include cellular phone services, and/or radio-frequency identification (RFID). In another example embodiment, the frequency range of the present invention covers only a narrow band of ˜200 MHz around 2.4 GHz or around a frequency between about 5.2 and about 5.8 GHz.

The main source of loss in cable 10 is due to the electrical-optical-electrical conversion process. In an example embodiment, this conversion loss is compensated for by amplifying the RF signals within the cable, e.g., at E/O converter units 20A and/or 20B using transimpedance amplifiers 64A and/or 64B.

Other Cable Applications

The main advantage of the cable of the present invention is that it can have standard RF connectors at each end, can have small physical dimensions, and can connect an access point device to an antenna to remotely locate one with respect to the other. Further, no separate electrical power needs to be supplied to the antenna-end of the cable, since this power comes through the cable from the access-point-end of the cable.

A cable user need not know of or even be aware of the fact that optical fibers are used to transport the RF signal over a portion of the signal path between the access point and the antenna. Due to the low optical fiber loss, relatively long cables can be used to span relatively long distances, e.g., 1 km or greater using multi-mode optical fiber, and 10 km or greater using single-mode optical fiber. The cable of the present invention can be used with any type of wireless communication system, and is particularly adaptable for use with standard WiFi systems that use common interfaces. For certain WiFi applications, WiFi communication protocols may need to be taken into account in the RF signal processing when using relatively long (e.g., 10 km or greater) cables.

The use of one or more patchcords, as described, above allows for easily extending the length of cable. Wireless systems based on cable of the present invention, such as described above, can be used in office buildings, shopping malls, libraries, airports, etc., where several access points are in a central location and the corresponding antennae are located in a place where there is no power available to power the antenna side of the system.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An electrical-optical cable apparatus for a wireless system, comprising:
first and second optical fibers each having opposite ends, and an electrical power line having opposite ends;
first and second electrical-optical (E/O) converter units each optically coupled to the first and second optical fibers at their respective opposite ends, and electrically coupled to the electrical power line at its respective opposite ends so as to provide electrical power from the first to the second E/O converter unit, the first and second E/O converter units having respective one or more first and second radio-frequency (RF) electrical connectors adapted to receive and/or transmit RF electrical signals; and
wherein the first and second E/O converter units are adapted to convert the RF electrical signals into RF optical signals and vice versa, so as to provide RF signal communication between the one or more first and second electrical connectors via the first and second optical fibers.

2. The cable apparatus of claim 1, wherein:
the first E/O converter unit receives and converts a first RF electrical signal to a corresponding first RF optical signal transmitted over the first optical fiber to the second E/O converter unit, which converts the first RF optical signal back to the first RF electrical signal and outputs the first RF electrical signal; and
wherein the second E/O converter unit receives and converts a second RF electrical signal to a corresponding second RF optical signal transmitted over the second optical fiber to the first E/O converter unit, which converts the second RF optical signal back to the second RF electrical signal and outputs the second RF electrical signal.

3. The cable apparatus of claim 1, wherein at least one of the first and second optical fibers are multi-mode optical fibers.

4. The apparatus of claim 1, wherein the first E/O converter unit includes an electrical power connector adapted to receive and engage an input electrical power line.

5. The apparatus of claim 4, including a power supply electrically connected to the electrical power connector via the input electrical power line.

6. The apparatus of claim 1, including input and output RF electrical connectors at each of the first and second E/O converter units.

7. The apparatus of claim 6, wherein the at least one of the input and output RF electrical connectors have an antenna electrically coupled thereto.

8. The apparatus of claim 1, including an antenna electrically connected to one of the second electrical connectors at the second E/O converter unit.

9. The apparatus of claim 1, including an RF electrical signal unit electrically connected to the first E/O converter unit and adapted to generate and provide input RF electrical signals to the first E/O converter unit.

10. The apparatus of claim 1, wherein the first E/O converter unit includes:
a first signal-directing element electrically connected to one of the one or more first RF electrical connectors and having a first input port and a first output port;
a first transmitter electrically connected to the first output port and optically coupled to an input end of the first optical fiber;
a first photoreceiver electrically connected to the first input port and optically coupled to an output end of the second optical fiber; and
wherein the first signal-directing element is adapted to direct the first RF electrical signal from the first RF electrical connector to the first transmitter, and direct the second RF electrical signal from the first photoreceiver to said one of the one or more first RF electrical connectors.

11. The apparatus of claim 10, wherein the second E/O converter unit includes:
a second signal-directing element electrically connected to one of the one or more second RF electrical connectors and having a second input port and a second output port;
a second transmitter electrically connected to the second output port and optically coupled to an input end of the second optical fiber;
a second photoreceiver electrically connected to the second input port and optically coupled to an output end of the first optical fiber; and
wherein the second signal-directing element is adapted to direct the second RF electrical signal from the second RF electrical connector to the second transmitter and direct the first RF electrical signal from the second photoreceiver to said one of the one or more second RF electrical connectors.

12. The apparatus of claim 1, wherein the first and second optical fibers and the electrical power line constitute a cord that includes first and second main cord sections respectively operatively coupled to the first and second E/O converter units and having a collective length, and further including one or more patchcords adapted to electrically and optically couple the first and second main cord sections so as to extend the collective length of the cord.

13. An electrical-optical cable apparatus for sending RF signals between an access point device and a wireless antenna, comprising:
a first electrical-to-optical (E/O) converter unit electrically coupled to the access point device so as to receive input radio-frequency (RF) electrical signals and input electrical power;
a second electrical-to-optical (E/O) converter unit electrically coupled to the antenna;
a cable operably connecting the first and second E/O converter units, the cable including: (a) first and second optical fibers, and (b) an electrical power line that provides electrical power from the first E/O converter unit to the second E/O converter unit; and
wherein the first and second E/O converter units are adapted to convert RF electrical signals into RF optical signals and vice versa, so as to provide RF signal communication between the access point and the antenna.

14. The cable apparatus of claim 13, including a power supply electrically coupled to the first E/O converter unit so as to provide electrical power to the first and second E/O converter units.

15. The cable apparatus of claim 13, wherein the first and second E/O converter units each include:
a transmitter adapted to receive and convert RF electrical signals into RF optical signals; and
a photoreceiver adapted to receive and convert RF optical signals into RF electrical signals.

16. The cable apparatus of claim 15, wherein the first and second E/O converter units each include a signal-selecting element electrically coupled to respective first and second RF electrical connectors and having an input and an output port, wherein the transmitter is electrically coupled to the output port and the photoreceiver is electrically coupled to the input port.

17. The cable apparatus of claim 13, further including electrical-optical insertable and removable patchcord sections that are used to adjust a length of the cable.

18. A method of transmitting radio-frequency (RF) signals between an access point device and a wireless antenna, comprising:
converting first RF electrical signals from the access point device into corresponding first RF optical signals at a first E/O converter unit;
transmitting the first RF optical signals over a first optical fiber from the first E/O converter unit to a second E/O converter unit;
converting the first RF optical signals back to the first RF electrical signals at the second E/O converter unit;
driving the antenna with the first RF electrical signals at the second E/O converter unit; and
powering the second E/O converter unit with power transmitted from the first E/O converter unit.

19. The method of claim 18, including:
receiving second RF electrical signals at the antenna;
converting the second RF electrical signals to corresponding second RF optical signals;
transmitting the second RF optical signals over a second optical fiber from the second E/O converter unit to the E/O converter unit;
converting the second RF optical signals back to the second RF electrical signals at the first E/O converter unit; and
outputting the second RF electrical signals from the first E/O converter unit to the access point device.

20. The method of claim 19, including providing electrical power to the first E/O converter unit and transferring some of the electrical power to the second E/O converter unit via an electrical power line that electrically couples the first and second E/O converter units, so as to power the second E/O converter unit.
